(19) United States
(12) Patent Application Publication
(10) Pub. No.: US 2003/0210240 A1
(43) Pub. Date: Nov. 13, 2003

(54) System and method for remotely controlling a distributed network of signs

(76) Inventors: Orlando J. Lacayo, Santa Clara, CA (US); Helen M. Davis, Cupertino, CA (US); Bryan Thomas Preas, Palo Alto, CA (US)

Correspondence Address: Pepper Hamilton LLP, One Mellon Center, 50th Floor, 500 Grant Street, Pittsburgh, PA, 15219, US

(21) Appl. No.: 10/397,061

(22) Filed: Jun. 26, 2003

Related U.S. Application Data
(60) Provisional application No. 60/367,315, filed on Mar. 25, 2002.

(51) Int. Cl. G09G 5/00

(52) U.S. Cl. 345/212

(57) ABSTRACT

A system and method for remotely updating messages displayed on a plurality of low power consuming electronic display devices. The system comprises a server computer remotely located from a bistable display device which is in wireless communication with a computer network connected to said server computer. The server computer manages the updating and display of messages on the display device by providing new content and scheduling the display of the content. Except when changing the message display or communicating with the server com

### CROSS REFERENCES

This application claims priority to U.S. Provisional Application Serial No. 60/367,315, filed Mar. 25, 2002, the contents of which are incorporated herein by reference in its entirety.

### BACKGROUND OF THE INVENTION

Signs are ubiquitous in our world today. They are found everywhere including stores, malls, airports, and schools. In spite of their widespread use, there is a large cost associated with managing signs, including the cost of card stock, printing, design, shipping, and the cost of electing signs. Adding further expense, signs are static: to change what is displayed, the sign itself must be changed. In an ever changing environment such as a retail location or an airport, this can cause the cost of signs to be increased by several multiples.

Nonetheless, merchants, have long utilized paper based signs in point of purchase advertising. Point of purchase advertising largely entails the use of signs in proximity to a product to generate sales of the product. Paper signs are also frequently used at the point of purchase to cross-sell (i.e. sell additional products) or up-sell (i.e. sell a more advanced/expensive version) to the customer. As used herein, point of purchase advertising shall mean the in-store presentation of information regarding a particular product, including at the point of presentation or the point of sale. Research into customer buying behavior in retail stores suggests that a significant portion of purchases result from promotions that customers see in the store. Attractive, informative and well-positioned advertising displays are, therefore a very important part of the sales promotional activity in retail outlets.

The cost of utilizing paper based signs used at the point of purchase or other frequently changing environments is frequently larger than when such signs are used in a more stable environment. Changing signs for “sales” or other promotions, updating schedules, adding new products, or even changing prices of existing products requires new signs be purchased and the labor costs associated with erecting the new signs. Further, checking price accuracy, on paper based signs requires employees devote a portion of their day to this task which could be spent on other activities. In addition, paper based displays are not well-suited for the real time display of advertising, cross-selling or up-selling, or the cost-effective changing of advertisements throughout a department store, or across an entire chain of stores.

Attempts to satisfy the need for more flexible and dynamic advertising media have generally focused on the use of LCD's, LED's CRT's and more recently plasma screen displays. Although such electronic devices allow for more dynamic advertising, they do so at significantly increased costs. In addition, signs utilizing LCD's, LED's, CRT's or plasma screens require a significant and continuous power supply, which usually limits the locations in which they can be placed to be in proximity to an electrical outlet or requires use of expensive and bulky batteries. As a result, these displays are typically impractical for widespread use throughout retail environment or other enterprise.

In order to provide retailers a store-wide, or even chain-wide, solution to their in-store advertising needs, a system of displays which are capable of being easily moved, easily updated and practical for wide ranging distributional is needed. The displays must be low cost, allowing the economical deployment of thousands of signs at a single store. In addition, the displays must be low power to allow mobility and economical use. In addition, the image displayed by the sign must be easy to read, easy to change on a schedule, and able to meet the demanding needs of the modem retail environment.

### SUMMARY OF THE INVENTION

The present invention describes a system and method for displaying information on a low power consuming display from a remote location. The system of the present invention comprises a server computer accessible by a user interface for managing the display of information on the display device, a plurality of communication devices in communication with the server computer, a plurality of display devices in communication with each of said communication devices, and a software program residing on the server computer where said software program is used to control the periodic updating of information displayed on the display device. The display device of present invention is comprised of an active sign substrate having a display area with plurality of display segments located therein, a display driver for switching the display segments between a plurality of stable states, a communication device for communicating data with remote locations, a micro-controller for controlling the display driver and the communication device and a power supply sufficient to meet power requirements of the display driver, communication device and the micro-controller.

In addition, described herein is a method for updating a message on a display device by powering such display device only as necessary to change the message being displayed. As a display device described herein is a device capable of operating a plurality stable of states, the method described herein obtains considerable power savings by only powering the device for purposes of changing the display then reducing the power to the display device without affecting the display of the updated message.

### BRIEF DESCRIPTION OF THE DRAWINGS

FIG. 1 is a block diagram of the system of the present invention.

FIG. 2 is a block diagram of the components of the display device of the present invention.

FIG. 3 is a block diagram of the components of the microcontroller preferably utilized by the display device.

FIG. 4 is a flow diagram of one embodiment of the process for updating a message on a display device utilizing the present invention.

FIG. 5 is a flow diagram of an alternate embodiment of the process for updating a message on a display device utilizing the present invention.

### DETAILED DESCRIPTION OF THE PREFERRED EMBODIMENTS

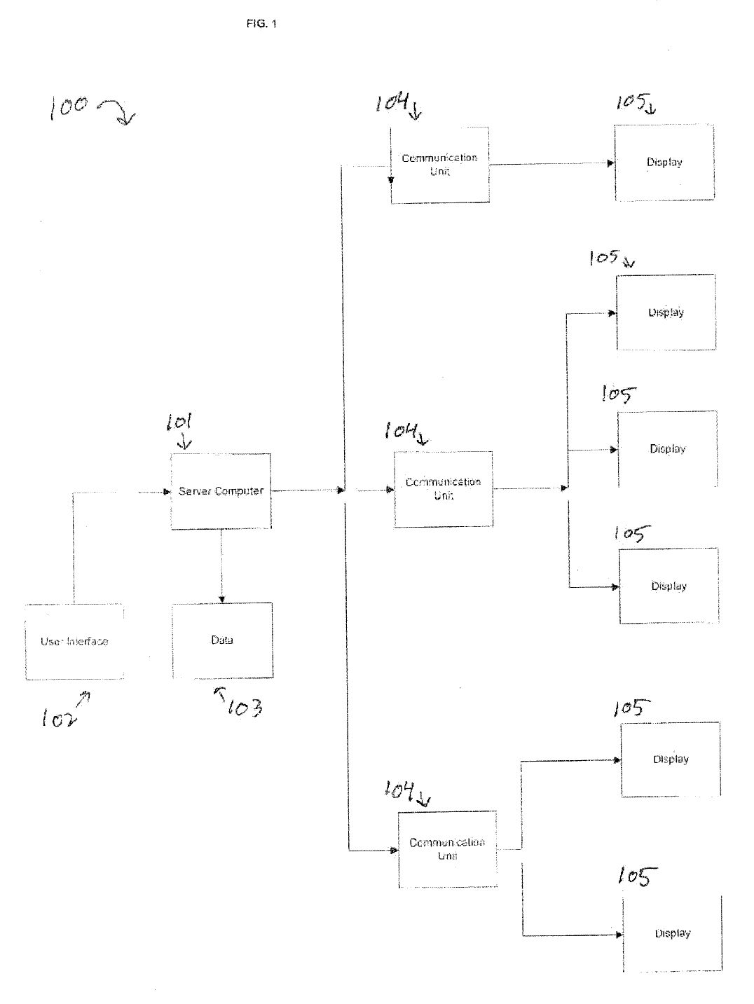

Referring to FIG. 1, there is shown a block diagram of the system for displaying information from a remote location. The system 100 is controlled by a server computer 101 with a user interface 102, such as a graphical user interface to allow for user intervention to the system. In addition, the server computer has access to a database 103 which contains data for creating messages to be displayed on the display devices and may also contain the schedule on which the display devices are to be updated as well as reporting and monitoring information. The server computer 101 may be connected to and exchange information with a central server computer, not shown, via a distributed computer network such as the internet or over a proprietary intranet. The central server computer, could remotely control a plurality of sign control systems 100. Graphical user interfaces could optionally be accessed on the server computer 101, on the central computer, or on another networked computer including portable handheld devices.

The server computer is in communication with plurality of communication devices 104 which provide for the exchange of data from the server computer to the display devices 105. Preferably, the communication devices 104 would be a transceiver for the bi-directional wireless transmission of data with the display devices 105. The communication devices 104 preferably transmit and receive data with the display devices 105 by wireless communication utilizing any proprietary wireless protocol or standard wireless protocols such as, by way of example only, any of the IEEE 802.11 standards or Bluetooth. In addition, the communication devices 104 may transmit data to the display devices 105 at as low as 100 kilobytes per second, taking advantage of the low band width requirements for updating the display device of the present invention.

In addition, the communication device 104 may power the display devices 105 through means such as use of an inductively coupled magnetic field. The communication devices 104 are in communication with the server computer 101 by way of a distributed computer network, such as the internet.

Furthermore, residing on the server computer 101 is a software program which is used to control the periodic updating of information displayed on the display device 105. As is known in the art, this software program may be implemented over a multi-tiered network computing platform distributed across one or more computers. The server computer 101 may also communicate with other computers or storage systems (not shown) over a network to obtain product information, promotional information, store information, environmental or news information, and associated image and information databases.

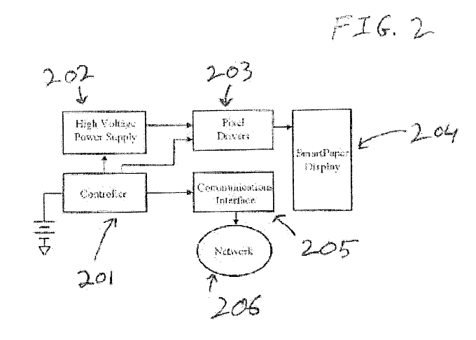

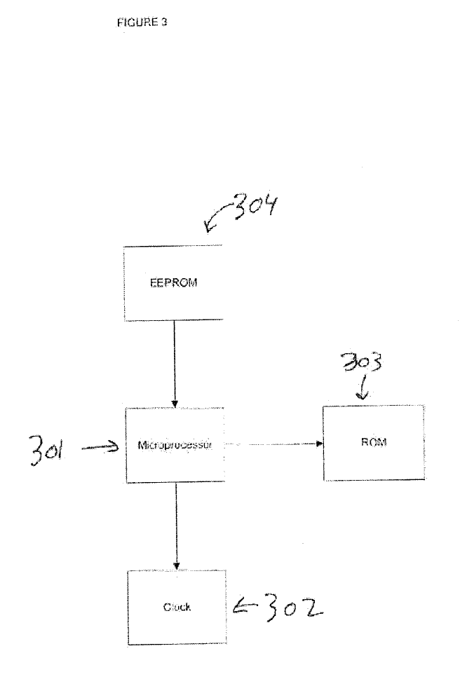

FIG. 2 is a block diagram of the architecture comprising the display device. The controller 201 provides for the timing and sequencing of the message to the displayed. The controller 201 is more fully shown in FIG. 3. As shown in FIG. 3, the microcontroller comprises a microprocessor 301, a clock 302, Read-Only Memory (ROM) 303 and Electrically Erasable Read-Only Memory (EEPROM) 304. The EEPROM 304 is sufficient to store updated messages and the schedule for updating the display device for a predetermined period of time.

Returning to FIG. 2, the high voltage power supply 202 supplies additional power to the pixel drivers 203 as needed to achieve the activation voltage level for the pixels. The pixel drivers 203 apply the voltage to the display material 204, which preferably is a bistable display material such as a gyricon sheet. Use of a bi-stable display material allows the display device to operate with reduced power consumption. Preferably, the display device would be comprised of a gyricon sheet and may be configured to allow for the display of messages using a multiple fixed image format such as that described more fully in U.S. Pat. No. 6,340,965 entitled “Modifiable display having fixed image patterns” which is incorporated herein by reference. Briefly, utilizing such a format, the display drivers 203 are associated with each of a limited number of fixed images allowing for a finite number of messages to be displayed. Switching between a limited number of fixed images reduces the power and communication requirements of the system; however, the architecture and techniques described herein also apply to bitmapped displays. The display drivers 203 are required to be powered only for switching the individual display segments between a plurality of stable states and are not necessary for the refreshing of the display. Updated messages and scheduling information is received by the communication interface 205 which is connected to the network 206 system by wireless communication.

The display devices may optionally include additional features which are not shown such as user interfaces, user controls, printers, sensors, mechanisms to change the display device from low power mode to full power mode (e.g. alternate communication channels, “wakeup” buttons), and similar features.

The display device described herein can optimally be used to consume significantly less power than other changeable electronic displays such as LCDs, by taking advantage of the bi-stable nature of the display, which requires powering of the display drivers only upon changing of the displayed message. The display device can be programmed to go into a reduced power mode or sleep mode and awaken only to receive data from the server computer and/or update the display message at predetermined intervals. Because the device consumes substantially less power, a broad range of power supplies may be utilized including such commonly available means as a rechargeable battery, disposable batteries, solar panels and coiled antennae for receiving an inductively coupled magnetic field. Although actual duration of the power supply will vary on usage, under normal retail usage, it is expected that a non-rechargeable power supply can operate the display device for a period of 18 to 36 months.

The substantial majority of the power consumed over the life of the display device is for driving the communication unit and the micro-controller, rather than the display driver. As a result, the display area of the display device may be increased largely independent of the power requirements for the device itself.

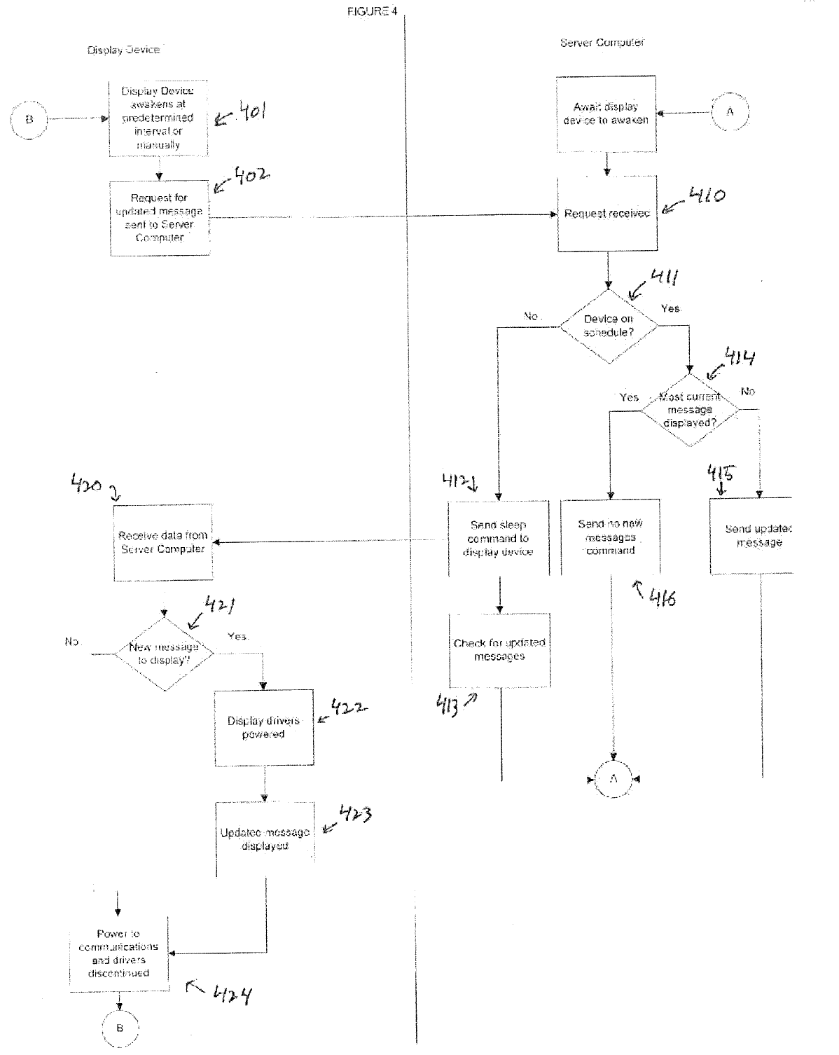

The system of the present invention may be utilized in any of a variety of settings where information displayed to customers or potential customers is required to be periodically updated. For example, the present invention may find use in retail environment, a transit environment (e.g. subway station, train station, bus station, airport) or other similar environments where easily changeable and mobile signs would be advantageous. As shown in FIG. 4, the display device remains in a reduced power made until either the time of the next scheduled update, upon receipt of an initiation command from the server computer, or direct intervention by a user at which time the communications unit is powered 401. Preferably included with the display devices is means for a user to cause the display device to check for updated messages, such as a direct intervention button. The display device goes into a full power mode and sends request for an updated message to the server computer 402. This request may preferably include information regarding the status of the display device such as its expected remaining battery life, its current message, etc. The request is received 410 at the server computer which checks if the display device is requesting the updated message pursuant to a predetermined schedule 411. If the display device is not requesting the updated message pursuant to a predetermined schedule, the server will send a command back to the display device 412 returning the display device to reduced power mode for a set period of time. At the expiration of that time period, the display device will return to full power mode and again query the server computer for an updated message. In the intervening time period, the server computer will determine if the display device is displaying the most current message 413.

If the display device is checking for updated messages pursuant to an agreed upon schedule, the server determines whether there is an updated message to be displayed 414. If an updated message is to be display, the new information and optionally a new time to check for updated messages is returned to the display 415. Otherwise, indication is returned to the display device that no updated message is available 416.

Upon receiving data from the server computer 420, which may include an updated message, the device determines if there is an updated message to be displayed 421. If there is an updated message, the display devices display drivers are powered 422, the updated message is displayed 423, and the entire device, including the display drivers, returns to reduced power mode 424. If the data received from the server computer does not include an updated message to be displayed 421, the power to the communications unit and the display drivers is discontinued 424 and the displayed message is unchanged.

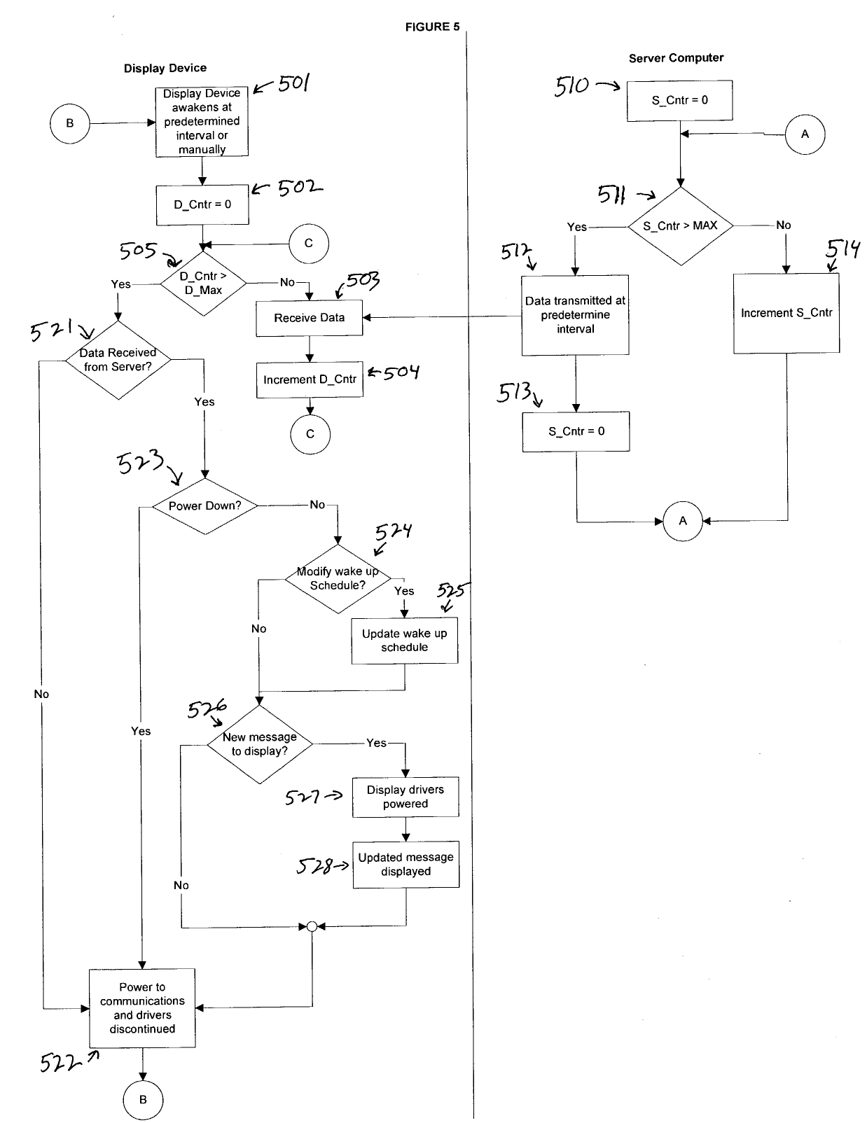

Alternately, as shown in FIG. 5, the display device awakens at pre-determined intervals or manually 501 and enters a loop to await data from the server computer. The display device sets a counter to zero 502 and listens for data 503 from the server computer. The counter is incremented 504 and the loop repeated until a maximum limitation is reached 505. The maximum limit is programmable and may be modified by command from the server computer or via commands received from alternate devices such as handheld wireless devices.

The server computer operates in a loop by setting a counter to zero 510 and, when such counter exceeds a maximum amount 511 proceeds to transmit data 512 to the display device and reset the counter 513. If the counter has not exceeded the maximum value, the counter is incremented 514 and the loop repeated.

When the device counter exceeds the maximum limit 502, the display determines if data has been received from the server computer 521. If no data has been received, the display device returns to low power mode by discontinuing power to the communications device and the display drivers 522. If data has been received, the display device next checks if a power down command 523 was received from the server computer. If the power down command has been received, the display device returns to the low power mode by discontinuing power to the communications device and the display drivers 522. If the power down command has not been received, the display device will check if other commands or information have been received from the server computer. As shown in FIG. 5, the display device will determine if a modified wake-up schedule 524 has been received from the server computer. If a new wake-up schedule has been received, the display device will update its locally accessible wake-up schedule 525 and proceed with processing. The display device next determines if a new message 526 has been received from the server computer. If a new message has not been received, the display device returns to low power mode by discontinuing power to the communications device and the display drivers 522. If a new message has been received, the display drivers are fully powered 527 and the updated message is displayed 528. Following display of the updated message, the device returns to the low power mode by discontinuing power to the communications device and the display drivers 522.

In addition, in order to further improve the power savings of the instant invention, communications between the display device and the server computer may be coordinated so that data is exchanged only at agreed upon times for the then current update. For example, when a display device is awakened either on schedule or manually (such as shown in FIG. 4 and FIG. 5) the display device would send indication to the server computer that the display device is awake. The display device and server computer would agree upon a data exchange schedule (which may originate at either the display device or the server computer) for the then current update. The display device could then return to low power mode and would awake only as dictated by the agreed upon data exchange schedule.

As described in both FIG. 4 and FIG. 5, the display device may be automatically awakened pursuant to a pre-determined schedule or may be manually awakened. The display device may be manually awakened by any number of different methodologies or devices including a button or switch which may optionally be installed on the display device and which automatically places the display device in the full power mode. Alternately, the device may receive a signal from an external device which causes the display device to enter a full power mode. Such signals may, for example, be low power communications such as low power radio frequency or high power communications such as high frequency sound, or other communication means to signal one or a plurality of the display devices to enter full power mode.

While the instant invention has been described in conjunction with the exemplary embodiments outlined above, it is evident that many alternatives, modifications and variations will be apparent to one of ordinary skill in the art. Accordingly, the exemplary environments of this invention as set forth above are intended to be illustrative, not limiting. Various modifications or changes may be made without departing from the spirit and scope of the invention or may occur to one skilled in the art of subsequent review of the present application. Such modifications or changes that are intended to be included within the scope of the present invention.

We claim:

1. A display device comprised of:
an active sign substrate having a display area with a plurality of display segments located therein;
a display driver for switching the display segments between a plurality of stable states;
a communication device for communicating data with a remote location;
a microcontroller for controlling the display driver and the communication device; and
a power supply sufficient to meet the power requirements of the display driver, the communication device and the microcontroller.

2. The display device of claim 1 wherein the display segments are arranged to display a plurality of characters.

3. The display device of claim 1 wherein the power requirement for the display driver is at least an order of magnitude smaller than the power requirement for the communication device.

4. The display device of claim 1 wherein the power requirement for the display driver is at least an order of magnitude smaller than the power requirement for the microcontroller.

5. The display device of claim 1 wherein the display area is scalable substantially independent of the power requirement for the display driver.

6. The display device of claim 5 wherein the power supply is a rechargeable battery.

7. The display device of claim 5 wherein the power supply is a non-rechargeable battery.

8. The display device of claim 5 wherein the power supply is a solar panel.

9. The display device of claim 5 wherein the power supply is a coiled antennae for receiving an inductively coupled magnetic field.

10. The display device of claim 9 wherein the coiled antennae is also used for receiving data transferred through the inductively coupled magnetic field.

11. The display device of claim 1 wherein the display area is at least 35 square inches.

12. The display device of claim 1 wherein the display area is at least 100 square inches.

13. The display device of claim 1 wherein the display area is at least 200 square inches.

14. The display device of claim 1 wherein the display area is at least 250 square inches.

15. The display device of claim 1 wherein the display device is disposable.

16. The display device of claim 1 wherein the communication device communicates data at a rate of up to one MBps.

17. The display device of claim 1 wherein the communication device communicates data at a rate of between 2 MBPS and 11 MBPS.

18. The display device of claim 1 wherein the communication device communicates data at a rate of between 11 MBPS and 55 MBPS.

19. The display device of claim 1 further comprising a clock for scheduling periodic updates of the display area.

20. A method of updating a message on a display device comprising:
powering the display device at pre-determined time intervals, such that the display device can request, receive and display the updated message;
sending a request for an updated message, such request being sent from the display device to a communications device connected to a remotely located computer remotely located from the display device;
receiving data from the communications device, such data including the updated message;
displaying the updated message on the display device; and
reducing power to the display device without effecting the display of the updated message.

21. The method of claim 20 wherein the power reduction step reduces the power consumed by the display device by at least an order of magnitude.

22. The method of claim 20 wherein the data received from the communications device includes the time of the next update.

23. The method of claim 20 wherein the request for an updated message includes diagnostic information regarding the display device.

24. The method of claim 20 wherein the powering step is initiated by a command received from the computer.

25. A system for controlling the display of information from a remote location comprising:
a central computer accessible by a user interface to manage the display of information over the system;
a plurality of communication devices in communication with the central computer;
a plurality of display devices in communication with said communication devices, said display devices being remotely located from said central computer; and
a software program residing on the central computer, said software program being used to control the periodic updating of information displayed on the display device.

26. The system of claim 25 further comprising a database accessible by said central computer, said database containing data for creating messages to be displayed on the display devices.

27. The system of claim 26 wherein said database further contains data for scheduling the periodic updating of information displayed on the display devices.

28. The system of claim 25 wherein the central computer communicates with the communication devices over a distributed computer network.

29. The system of claim 28 wherein the distributed computer network is the internet.

30. The system of claim 25 wherein the central computer is in wireless communication with the communication devices.

31. The system of claim 25 wherein the display device is a bistable display device.

32. The system of claim 25 wherein each of the display devices is assigned a unique identifying address.

33. The system of claim 32 wherein the unique identifying address is an IP address.

34. The system of claim 35 which the communications device is a wireless communications device.

35. The system of claim 34 wherein the communications device communicates with the display device at a frequency of up to 2.4 Ghz.

36. The system of claim 34 wherein the communications device communicates with the display device at a frequency of up to 5.8 Ghz.
